(19) United States
(12) Patent Application Publication
(10) Pub. No.: US 2014/0283926 A1
(43) Pub. Date: Sep. 25, 2014

(54) Foldable, Double-Block and Bleed Plugging Tool

(71) Applicant: Joshua Duell, Tulsa, OK (US)

(72) Inventor: Joshua Duell, Tulsa, OK (US)

(21) Appl. No.: 13/847,285

(22) Filed: Mar. 19, 2013

(51) Int. Cl. F16K 31/60

(52) U.S. Cl. CPC F16K 31/60
USPC 137/315.42

(57) ABSTRACT

An isolation tool for temporarily isolating a section of pipeline has foldable semi-circular sealing element halves that, when unfolded, combine to form a primary and secondary sealing element. The element halves unfold by rotating an inner bar about an outer bar. A bleed hole permits any fluid which leaks past the primary sealing element and into the annular space between the sealing elements to enter a longitudinal bleed passageway located within the tool itself, thereby eliminating the need for a bleed port or valve to be welded onto the pipeline. The tool, which is pressure balanced, is well adapted for use in applications in which the lateral access opening is significantly smaller in diameter than the pipe diameter.

### BACKGROUND OF THE INVENTION

This invention relates generally to pipe isolation tools or plugs which are inserted into (and retracted from) a lateral access opening in a section of pipeline and temporarily block the flow of pipeline product through that section. More specifically, the invention relates to “double block and bleed” isolation tools and plugs used in combination with hot tapping operations on pipelines which carry high or low pressure fluids, high or low temperature fluids, steam, dangerous fluids, and environmentally hazardous fluids.

Double block and bleed is a well-known term of art that refers to setting two seals in a pipe and opening a bleed port between the two seals to ensure that the first (primary) seal is holding. Any leakage past the primary seal is contained by the second (redundant) seal and forced to exit through the bleed port. This arrangement ensures that the pipe is completely sealed, making it safe to work on the pipe downstream of the two seals.

Some prior art double block and bleed plugs make use of a single, metal-to-metal plugging seal or the use of two independent pluggers and fittings. Both approaches are expensive; use relatively large, heavy components; and require a lot of equipment to properly install. Additionally, the metal-to-metal plugging seal approach does not allow for bypassing pipeline product through a fitting. If a bypass is required, a second fitting must be installed upstream of the plugging seal.

An improved double block and bleed plug is disclosed in U.S. Pat. Nos. 7,841,364 and 8,307,856 to Yeazel et al. The plug, which is designed for use in size-on-size applications, has a secondary or redundant plugging head pivotally connected to a primary plugging head which, in turn, is pivotally connected to a carrier. As the carrier travels downward through the lateral access opening, each plugging head rotates into sealing position downstream of the lateral access opening. A fitting must be welded around the pipe to provide a bleed port for the annular space or chamber located between the two plugging heads.

U.S. Pat. No. 7,866,347 to Bowie discloses an isolation tool which is designed for use in size-on-size applications. The tool has a sealing unit with primary and secondary sealing elements which define an annular chamber in between. For the tool to work properly, the sealing elements must be positioned upstream of the lateral access opening in the pipeline section. Positioning the sealing elements upstream of the lateral access opening has the disadvantage of requiring a second pipeline fitting if product flow is to be diverted around the isolated section.

U.S. Pat. No. 3,442,295 to ver Nooy discloses a foldable plugging tool which is useful for traversing a small diameter lateral access opening and temporarily blocking a larger diameter section of pipe. However, the tool does not provide double block and bleed capability, nor is it pressure balanced to permit easy insertion and retraction.

A need exists for a double block and bleed isolation tool which can be used in applications in which the diameter of the lateral access opening is significantly smaller than that of the pipeline and does not require the use of a bleed port external to the tool itself in order to bleed the annular chamber located between the primary and secondary sealing elements.

### SUMMARY OF THE INVENTION

A pipeline isolation tool made according to this invention is used in connection with a pipeline hot tapping operation in order to temporarily block or plug a section of the pipeline. The tool includes an outer bar and an inner bar which rotates about the outer bar. A pair of semi-circular backing plates is attached to the bars, with one backing plate in the pair attached to the inner bar and the other backing plate attached to the outer bar. Each backing plate carries a set of spaced-apart semi-circular sealing element halves. As the inner bar rotates about the outer bar, one set of semi-circular sealing element halves moves toward the other set to form two circular sealing elements. One of the circular sealing elements serves as the primary sealing element and the other serves as the secondary or redundant sealing element.

When the primary and redundant sealing elements are in a sealing position within a pipeline, fluid pressure activates the peripheral sealing edges of the elements into sealing engagement with the pipeline wall. A bleed hole is located in the backing plate of the secondary sealing element so that any pipeline fluid which leaks past the first sealing element can enter the annular area between the two sealing elements and be evacuated from the annular area through a bleed passageway and port in the tool itself.

Objects of this invention include providing a pipeline tool with double block and bleed capability that
1) has sealing elements which are foldable or moveable between a collapsed and expanded position to permit collapse of the elements into a shape for passage through the lateral access opening and expandable into a shape for sealing engagement within the pipeline section;
2) can be used in size-on-size applications in addition to applications in which the lateral access opening is significantly smaller in diameter than the section of pipe to be blocked;
3) does not require that a bleed valve or port be installed on the section of pipe in order to bleed the annular space located between the primary and redundant sealing elements; and
4) can be inserted downstream of the lateral access opening.

### BRIEF DESCRIPTION OF THE DRAWINGS

FIG. 1 is an isometric view of a preferred embodiment of a pipeline isolation tool made according to this invention. The sealing elements of the tool are shown in their deployed or expanded position.

FIG. 2 is an isometric view of the tool of FIG. 1 shown in its folded or collapsed position. The inner bar of the tool carries one set of semi-circular sealing element halves and the outer bar carries a second semi-circular sealing element halves. The inner bar rotates about the outer bar to form the circular sealing elements shown in FIG. 1, with one circular sealing element being the primary sealing element and the other being the secondary or redundant sealing element.

FIG. 3 is an enlarged view of section 3-3 of FIG. 2. Because the sealing elements are “folded,” the tool can traverse a lateral access opening having about half the diameter as the pipeline to be plugged (e.g., a 3-inch lateral access opening and a 6-inch pipeline).

### ELEMENTS AND ELEMENT NUMBERING USED IN THE DRAWINGS

10 Foldable, double block and bleed plugging tool
11 Inner bar
13 Back plate
15 Bleed plate
17 Set of sealing element halves
19 Nose plate
21 Handle
31 Outer bar
33 Back plate
35 Bleed plate
37 Set of sealing element halves
39 Nose plate
41 Handle
51 Fastening means
61 Primary sealing element
63 Sealing lip
65 Annular area
67 Secondary sealing element
69 Sealing lip
71 Bleed hole
73 Bleed passageway
75 Bleed port
81 Housing

### DETAILED DESCRIPTION OF THE PREFERRED EMBODIMENTS

A foldable, double block and bleed plugging tool made according to this invention is well-adapted for use in plugging applications in which the lateral access opening or connection to the pipeline to be plugged is significantly smaller in diameter than that of the pipeline (e.g., “n”-inch diameter lateral access connection and “2 n”-inch diameter pipe).

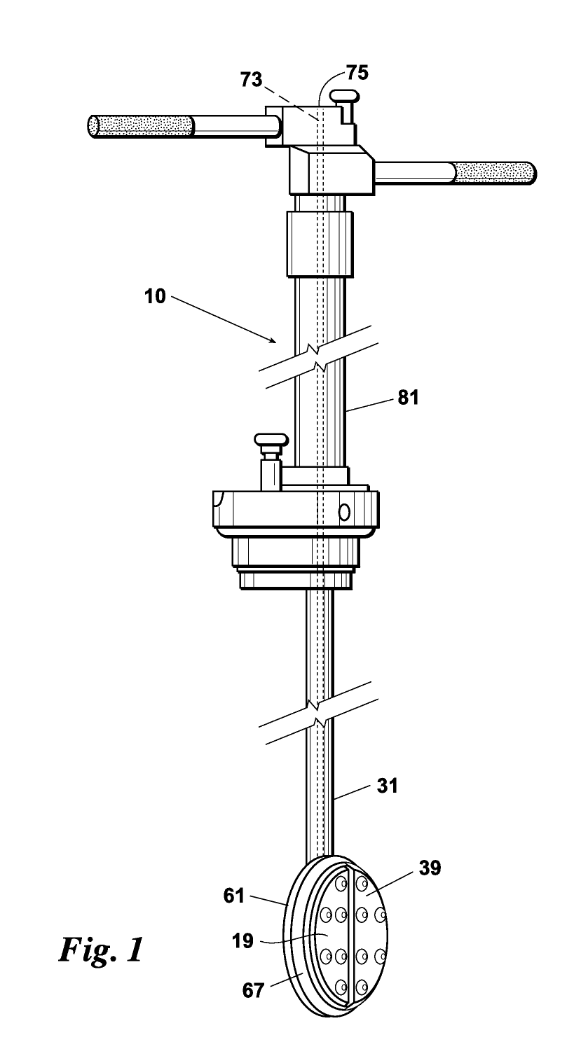

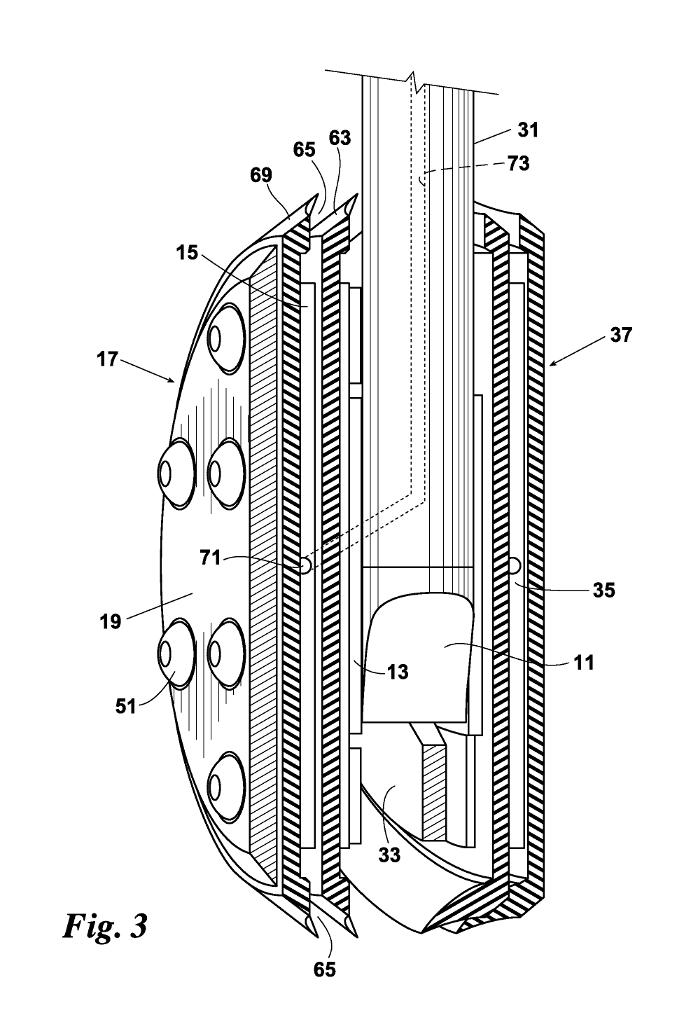

Referring to FIGS. 1-3, a tool 10 made according to this invention has an inner shaft or bar 11 and an outer bar 31. Each bar 11, 31 is coaxial to the other bar 31, 11. When in use, the bars 11, 21 extend through, and are in sealing relationship with, a fluid-tight housing or fitting F which is then received by a pipeline fitting (not shown). The pipeline fitting is of a type well known in the art and surrounds a lateral access opening the pipeline. The lateral access opening may be considerably smaller in diameter than the inside diameter of the pipeline.

Connected to the inner bar 11 is a back plate 13 which carries a set of carries a set of spaced semi-circular sealing element halves 17 in a “stacked” relationship. Fastening means 51 run through the nose plate 19 and the sealing element halves 17 to connect the nose plate 19 and sealing element halves 17 to the back plate 13. A weld connects the bar 11 to back plate 13.

Connected to the outer bar 31 is a back plate 33 which carries a set of carries a set of semi-circular sealing element halves 37 in a stacked relationship. Fastening means 51 run through the nose plate 39 and the sealing element halves 37 to connect the nose plate 39 and sealing element halves 37 to the back plate 33. A weld connects the bar 31 to back plate 33. Each sealing element half in the set 17, 37 is made of material known in the art. Because of the need to navigate small diameter lateral access connections, and because the sets 17, 37 fold, the thickness of each sealing element in the set 17, 37 is about half that of prior art sealing elements. Therefore, reinforcing the elements with fiberglass or its equivalent is preferred.

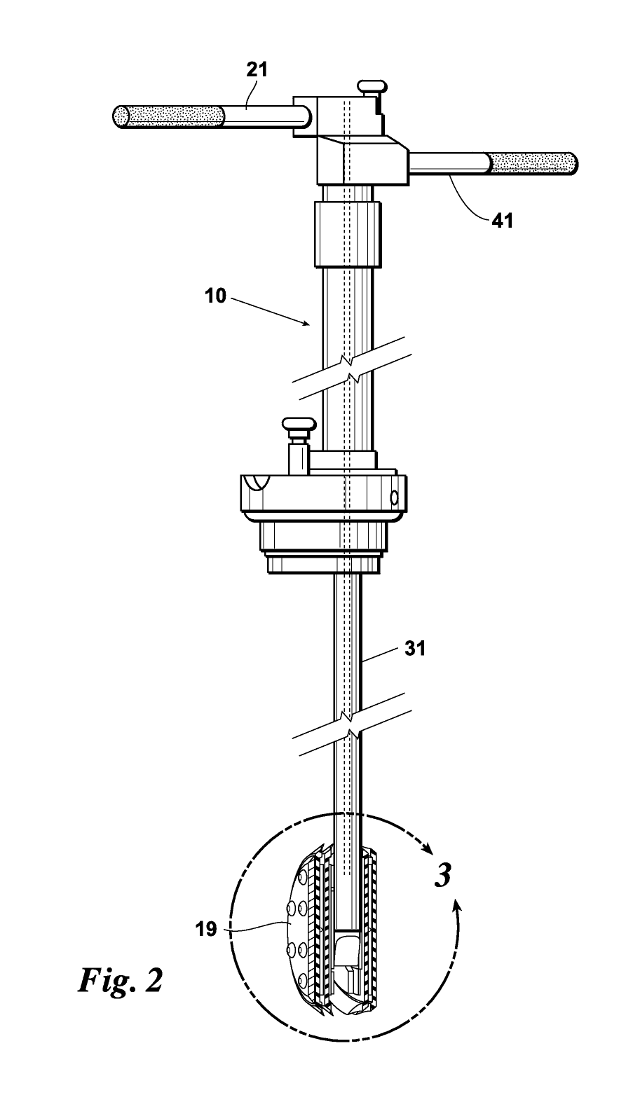

When tool 10 is in use to isolate a section of pipeline, the inner bar 11 rotates about (or around) the outer bar 31 by way of a handle 21. Handle 41 helps keep the outer bar 33 stationary. The rotation causes the sealing element halves 17, 37 to move between a folded or collapsed (non-sealing) position to an expanded (sealing) position (see FIG. 1). The collapsed position (see FIG. 2) permits movement of the tool 10 through a lateral access opening having about half the diameter as the pipeline diameter.

When in the expanded position, the sealing element halves 17, 37 form a circular primary sealing element 61 and a secondary or redundant sealing element 67. The elements 61, 67 are energized by fluid pressure and their respective sealing edges or lips 63, 69 urge against the pipeline wall. Fluid pressure, as well as the radial inward forces generated from sealing engagement with the pipeline wall, forces the sealing element halves 17, 37 into tight engagement with one another.

Between each sealing element in the set of sealing element halves 17 is a bleed plate 15. Similarly, between each sealing element in the set of sealing element haves 37 is a bleed plate 35. The bleed plates 15, 35, have a bleed hole 71 so that any pipeline product which flows past the primary sealing element 61 can enter the annular area 65 located between element 61 and secondary sealing element 67. Bleed hole 71 is in communication with a bleed passageway 73 through tool 10 and a bleed port 75 located toward an upper end of tool 10. This arrangement eliminates the need for a separate bleed port or valve to be welded onto the pipeline between the two plug sealing elements 61, 67.

The tool 10 may be removed from the pipeline and through the lateral access opening by returning the sealing elements 61, 67 to the folded or collapsed position. Unlike prior art, single block, folding plugging tools, the tool 10 is pressure balanced such that pipeline product is allowed to flow between the outer bar 31 and the housing 81. This pressure balancing allows for easy insertion and retraction of tool 10 to and from the pipeline.

The embodiments described above are preferred embodiments of a foldable, double block and bleed plugging tool made according to this invention. The preferred embodiments are not all possible embodiments. The scope of the invention is defined by the claims, including elements which are equivalent to those listed in the claims.

What is claimed:

1. An isolation tool for temporarily isolating a section of pipeline, the isolation tool comprising:
an inner bar and an outer bar, the inner bar being arranged for rotation about the outer bar;
a longitudinal bleed passageway located within the inner bar;
a set of spaced-apart semi-circular sealing element halves connected to each bar;
a plate located between the semi-circular sealing element halves and having a bleed hole;
a longitudinal bleed passageway located within at least one of the inner bar and the outer bar and in communication with the bleed hole;
wherein a circular primary sealing element and a secondary sealing element is formed as the inner bar rotates about the outer bar to bring each set of spaced-apart semi-circular sealing element halves into engagement with the other.

2. An isolation tool according to claim 1 wherein no bleed port is required on the section of pipeline to be isolated in order to bleed a pipeline fluid which resides in an annular space located between the circular primary and secondary sealing elements.

3. An isolation tool according to claim 1 wherein the primary and secondary sealing elements are configured for use downstream of a lateral access opening in the section of pipeline to be isolated.

4. An isolation tool according to claim 1 wherein the spaced-apart semi-circular sealing elements when in a folded position can travel through a lateral access opening having a diameter “n” and when in an unfolded position and forming the circular primary and secondary sealing elements can seal a pipe having a diameter “2 n”.

5. An isolation tool according to claim 1 further comprising a housing arranged about the outer bar so that a pipeline product is allowed to flow between the housing and the outer bar.
